(19) United States
(12) Patent Application Publication
(10) Pub. No.: US 2022/0080520 A1
(43) Pub. Date: Mar. 17, 2022

(54) Gas Nozzle for the Outflow of a Protective Gas Stream, and Torch with a Gas Nozzle

(71) Applicant: Alexander Binzel Schweisstechnik GmbH & Co. KG, Buseck (DE)

(72) Inventors: Sascha ROSE, Fernwald (DE); Andreas NOLL, Dillenburg (DE)

(73) Assignee: Alexander Binzel Schweisstechnik GmbH & Co. KG, Buseck (DE)

(21) Appl. No.: 17/299,007

(22) PCT Filed: Dec. 19, 2019
(86) PCT No.: PCT/EP2019/086455

§ 371 Date: Jun. 2, 2021

(30) Foreign Application Priority Data
Jan. 11, 2019 (DE) 10 2019 100 581.7

(51) Int. Cl. B23K 9/29; B23K 9/16; B23K 9/32; H05H 1/34; B23K 1/005; B23K 3/053

(52) U.S. Cl. CPC B23K 9/291; B23K 9/164; B23K 3/053; H05H 1/3457; B23K 1/005; B23K 9/322

(57) ABSTRACT

A gas nozzle for the outflow of a protective/shielding gas stream from a gas outlet of the gas nozzle having a gas distributor/diffuser section has a double-walled configuration at least in a partial area of the gas distributor/diffuser section in order to create a flow space for the protective/shielding gas stream. The invention also relates to a torch neck and to a method for thermally joining at least one workpiece, in particular for arc joining, preferably for arc welding or arc brazing/soldering, with an electrode which is arranged in the torch neck or with a wire for producing an arc between the electrode or the wire and the workpiece, and having a gas nozzle for the outflow of a protective/shielding gas stream from a gas outlet.

### CROSS-REFERENCE TO RELATED APPLICATIONS

This application is a national stage application (under 35 USC § 371) of PCT/EP2019/086455, filed Dec. 19, 2019, which claims benefit of German application No. 10 2019 100 581.7, filed Jan. 11, 2019, the contents of each of which are incorporated by reference herein.

### BACKGROUND OF THE INVENTION

### Technical Field and State of the Art

Thermal arc joining methods utilize energy to fuse the workpieces and to connect them. “MIG”, “MAG” and “TIG” are standard welding methods that are employed in sheet metal processing.

When it comes to shielding gas-assisted arc welding methods employing a consumable electrode (MSG), “MIG” stands for “metal inert gas” and “MAG” stands for “metal active gas”. In the case of shielding gas-assisted arc welding methods employing a non-consumable electrode (TSG), “TIG” stands for “tungsten inert gas”. The welding devices according to the invention can be configured as machine-controlled welding torches.

MAG welding is a metal shielding-gas (MSG) welding process with active gas in which the arc burns between a continuously fed, consumable wire electrode and the material. The consumable electrode supplies the filler material to form the weld seam. MAG welding can be easily and cost-effectively employed with almost all welding-appropriate materials. In this context, different shielding gases are employed, depending on the requirements and on the material.

In the case of metal shielding-gas (MSG) welding, the fed-in active gas protects the electrode, the arc and the welding bath vis-à-vis the atmosphere. This ensures good welding results with a high melting capacity under a wide array of conditions. As a function of the material, a gas mixture consisting of argon CO₂, argon O₂ or pure argon or else pure CO₂ is used as the shielding gas. Depending on the requirements, different wire electrodes are employed. MAG welding is a robust, cost-efficient and versatile welding process that is well-suited for manual, mechanical and automated processes.

MAG welding is suitable for welding unalloyed or low-alloyed steel grades. As a matter of principle, high-alloyed steel grades and nickel-based alloys can also be welded by means of the MAG process. The content of O₂ or CO₂ in the shielding gas, however, is small. Varying arc types and welding processes such as the standard process or the pulsed process are employed, depending on the requirements being made of the weld seam and on the optimal welding result envisaged.

Arc welding devices generate an arc between the workpiece and a consumable or non-consumable welding electrode in order to fuse the material that is to be welded. A stream of shielding gas shields the material that is to be welded as well as the welding site against the atmospheric gases, mainly N₂, O₂, H₂, that are present in the ambient air.

In this context, the welding electrode is provided on a torch body of a welding torch that is connected to an arc welding device. The torch body normally has a group of internal components that carry welding current and that conduct the welding current from a source of welding current in the arc welding device via the tip of the torch head to the welding electrode, where it then generates the arc to the workpiece.

The shielding gas stream flows around the welding electrode, the arc, the welding bath and the heat-affected zone on the workpiece, and in this process, it is fed to these areas via the body of the welding torch. A gas nozzle conveys the shielding gas stream to the front end of the torch head, where the shielding gas stream exits from the torch head around the welding electrode in an approximately annular pattern.

In the state of the art, as a rule, the gas is conveyed to the gas nozzle via components made of a material having low electric conductivity (polymers or oxide ceramics) which can concurrently serve as insulation.

During the welding procedure, the arc generated for the welding heats up the workpiece that is to be welded as well as any optionally added welding material, so that these are fused. The input of arc energy, the high-energy heat radiation and the convection all give rise to a significant input of heat into the head of the welding torch. Some of the introduced heat can be dissipated again by the shielding gas stream that is conveyed through the torch head or by the passive cooling in the ambient air as well as by heat conduction into the hose pack.

However, above a certain welding current load of the torch head, the heat input is so high that so-called active cooling of the torch head is necessary in order to protect the employed components against thermal material failure. Towards this end, the torch head is actively cooled with a coolant that flows through the torch head, thereby carrying away the unwanted heat that has been picked up during the welding process. For example, de-ionized water to which ethanol or propanol has been added can be employed as a coolant for purposes of providing protection against freezing.

Aside from welding, soldering is also an option when it comes to joining sheet metal components. Unlike in the case of welding, with soldering, it is not the workpiece that is melted but rather only the filler material. The reason is that, in soldering, two edges are joined together by the solder as the filler material. The melting temperatures of the solder material and of the component materials are very different, which is why only the solder melts during processing. Aside from TIG, plasma and MIG torches, lasers are likewise suitable for soldering.

The arc soldering processes can be broken down into metal shielding gas soldering (MSG-S) processes and tungsten-shielding gas soldering (TSG-S) processes. For the most part, copper-based materials in wire form, whose melting ranges are lower than those of the base materials, are used here as the filler material. In terms of the equipment employed, the principle of MSG arc soldering is largely identical to MSG welding, using filler material in wire form. In the case of TSG soldering, the filler material in wire form is fed into the arc either manually or mechanically from the side. In this process, the filler material can be fed in either de-energized as a cold wire or else energized as a hot wire. Greater melting capacities are achieved with a hot wire although the arc is influenced by the additional magnetic field.

As a rule, arc soldering is used on surface-finished or uncoated thin-gauge sheet metal since, among other things, the lower melting temperature of the solder in comparison to welding accounts for less thermal stress for the components, and the coating is only damaged to a lesser extent. No appreciable melting of the base material occurs in the case of arc soldering.

The arc soldering processes are normally employed on uncoated and metal-coated sheet metal made of unalloyed or low-alloyed steel within the thickness range of up to approximately 3 mm at the maximum.

Usually, argon II or argon mixtures with admixtures of CO₂, O₂ or H₂ according to DIN ISO 14175 are used for arc soldering. Commercially available TIG torches can be employed for TIG soldering.

European patent specifications EP 2 407 267 B1 and EP 2 407 268 B1 disclose a welding torch with a shielding-gas feed means, a torch connecting block, a torch neck that adjoins one end of the torch connecting block, and a torch head situated on the other end of the torch neck, wherein the torch neck has an inner pipe, an outer pipe and insulation tubing situated between the inner pipe and the outer pipe.

Such welding torches are used in the state of the art for metal inert gas (MIG) welding, among others. For instance, such a welding torch is described in German patent application DE 10 2004 008 609 A1. With this welding torch, the welding current is fed via the contact nozzle to the welding wire located in the inner pipe. In this context, the external parts of the torch are electrically insulated from the inner pipe in order to prevent the welding current from flowing via the torch housing. During the welding process, the welding wire heats up and this heat is partially conveyed into the welding torch.

Generically, the welding gas that is being used in the welding process anyway is mostly an inert shielding gas that can be employed very effectively to cool the inner pipe. Effective cooling of the inner pipe can be achieved if the gas flows in flat channels along the outside of the inner pipe. The state of the art uses an outer sleeve on the inner pipe in order to create gas-flow channels on the outside of the inner pipe. The assembly consisting of the inner pipe and the outer sleeve is then insulated from an outer housing pipe by means of insulation tubing.

Generically, the shielding gas is at first fed through the shielding-gas feed means which is typically in the form of a hole drilled in the torch connecting block. Since the shielding gas is fed asymmetrically to the inner pipe, the shielding gas should be diffused around the inner pipe as uniformly as possible. Towards this goal, for example, European patent specification EP 2 407 267 B1 proposes for the outer ring channel to be formed inside the torch connecting block and around the inner pipe, so that the shielding gas can be diffused around the inner pipe. Therefore, the shielding gas starts flowing from the drilled hole in the connecting block via the outer ring channel and the radial gas channels to the interstice between the inner pipe and the insulation tubing or optionally also to the interstice between the insulation tubing and the outer pipe.

European patent application EP 0 074 106 A1 discloses a water-cooled shielding-gas welding torch for welding with a continuously consumable electrode for automatic welding devices. Periodic cleaning by means of air blasts is to be effectuated by the coaxial arrangement of two outer profile pipes which are electrically insulated from each other and whose grooves are configured as channels. These channels extend from the torch head that has the gas nozzle on a gas-nozzle holder all the way to a torch body. At the same time, the shielding-gas inner channels should serve to feed blow-out air into the gas nozzle during the periodic cleaning of the gas nozzle. The outer water channels extend all the way to the gas nozzle holder so that this holder is cooled directly. Due to a special configuration of the torch body and of the connecting parts, the shielding gas or compressed air for the blow-out air and the cooling water is fed to the coaxially arranged profile pipes.

European patent application EP 2 487 003 A1 discloses a welding gun of an arc-welding device that, at one welding end, has a sleeve-shaped gas nozzle with a wall that surrounds a passage channel, and that, in the gas nozzle, has a gas diffuser with gas outflow openings. The gas nozzle has a connecting structure on one connection end in the interior on the inside of the wall. In the gas nozzle, a continuous, surrounding projection is formed on the inside of the wall behind the connecting structure as seen in the direction of the gas outlet end, and this projection brings about a reduction in the cross section of the passage channel vis-à-vis the surroundings of the projection. Moreover, as seen in the direction of the gas outlet end, the gas diffuser has a corresponding setback in front of the gas outlet openings.

A disadvantage of this is that the gas diffuser is protected and held by means of an annular groove but not firmly connected to it. For this reason, there is no guarantee that the gas diffuser cannot be lost if it is not screwed in. After all, the gas nozzle is screwed onto this torch having a wire guide and a gas diffuser. Accordingly, the gas diffuser is not connected in a captive manner to the gas nozzle but rather to the rest of the torch.

Automatic cleaning of the gas nozzle described in European patent application EP 2 487 003 A1 is likewise not possible since the gas nozzle is only held by the annular groove but is not firmly connected to it. For this reason, it is not secured against turning, even when it is screwed in.

Japanese published unexamined patent application JPA 1985072679 discloses an arc-welding method. A shielding gas flows centrally from a gas nozzle arranged in an inner pipe. A gas diffuser that can mounted on the torch body is made of an electrically insulating material.

Japanese registered utility model application JPU 11982152386 discloses an arc-welding torch with a consumable electrode, wherein the shielding gas is fed centrally into the torch neck and exits through holes in a gas diffuser. The gas diffuser is made of an electrically insulating material.

Japanese patent application H07 256462 A discloses a welding torch with a tip that has an insulating connection as well as a baffle attached to the insulating connection. A nozzle is arranged on the insulating connection. An electrode wire is fed in by means of an electrode wire feed means. In order to influence the flow of the shielding gas, a separating and deflecting part installed between the inner wall of the nozzle and the tip is screwed to the insulating connection. The separating and deflecting part is intended to prevent the torch and the nozzle from being electrically short-circuited due to spatter on the inner wall of the torch.

U.S. Pat. Appln. No. 2017/080512 A1 discloses a welding torch system with a receiving assembly to receive a contact tip and a welding nozzle. The welding torch system also includes a locking element that retains the contact tip in a partially secure position. Further, the welding torch system includes the welding nozzle configured to couple to the receiving assembly in order to retain the contact tip in a fully secure position.

The Internet site https://www.vdma.org/en/v2viewer/-/v2article/render/15157542 (download date: Dec. 1, 2020) discloses a one-piece mixing nozzle with a flow diameter of approximately 25 mm for mixing gaseous media into a liquid stream. The production of the mixing nozzle makes use of an additive manufacturing technique in which the component is built up in layers on the basis of a metal powder, and employing the selective laser melting method. The use of an additive manufacturing technique makes it possible to produce the components integrally in one piece.

Japanese patent application JP S 62 38772 A discloses a welding torch for shielding-gas welding having a contact tip and a cylindrical nozzle. The contact tip is screwed into a cylindrical gas diffuser.

German translation of published international application DE 602 24 140 T2 discloses a welding torch for use in metal shielding-gas welding. The welding torch has a neck section and a diffuser at a first end of the neck section. A contact tip extends from the diffuser. A connection means is situated at a second end of the neck section and serves to connect the neck section to a power cable assembly. The neck section has an electric conductor and a passage that extends longitudinally. A gas serves to protect the welding points from atmospheric impurities if the welding points are created using the welding torch. The gas flows out of the welding torch from the power cable assembly along the passage and through openings in the diffuser.

When it comes to welding torches of the generic type, especially MSG (metal shielding-gas) welding torches, among other things, the contacting of the wire electrode to the welding potential in the flow nozzle, takes place at the front end, and so do the rectification and laminarization of the shielding gas stream to the material to be welded, especially to the workpiece. Moreover, in the case of liquid-cooled systems, some of the process heat is transferred to the cooling circulation system.

Therefore, for optimal cooling of the wearing parts, for example, the contact tip, the distance from the heat source, that is to say, from the welding process, to the cooling circulation system in the case of liquid cooling, should be designed to be as short as possible. The rectification and laminarization of the shielding gas stream call for a sufficient retention time brought about by a suitable geometry in the shielding gas feed means, especially inside of the wearing parts. Moreover, the outer pipe and the inner pipe of the MSG welding torch also have to be electrically insulated from each other.

When the welding process is being carried out, depending on the process parameters, more or less spatter can adhere to the wearing parts. In MSG welding torches, as a rule, these adhesions are removed in automatically controlled systems by means of a motor-powered cleaning apparatus using a milling tool. The wearing parts, particularly the gas nozzle or the contact tip as well as an insulator, all have to withstand these mechanical stresses.

In the case of prior-art torch necks, for example, the model series “ABIROB® W500” manufactured by the applicant, the shielding gas can be fed centrally in the inner pipe. The term “central gas feed” designates those designs in which the shielding gas can be fed together with the filler wire in the interior of the inner pipe. Consequently, the inner pipe can be configured with a single wall. Owing to the holes in the nozzle holder, the shielding gas stream radially enters into a spatter protection means and exits in the direction of the gas nozzle. The spatter protection means is configured in such a way that, in addition to diffusing the gas, it also provides electric insulation.

When the contact tip and the gas nozzle are being cleaned, for instance, with a milling tool, the spatter protection means is at a sufficient distance from the milling tool so that it is not damaged.

In the case of other prior-art torch necks, especially those of the model series “ABIROB® W600” manufactured by the applicant, the shielding gas is fed decentrally in the inner pipe. When it comes to a decentralized gas feed, the shielding gas is conveyed in a double wall of the inner pipe. In other words, the inner pipe is then a composite pipe or a combined pipe-in-pipe connection, wherein one pipe is profiled so that interstices can form between the two pipe walls. The shielding gas stream exits radially via holes in the inner pipe. The shielding gas then enters the gas nozzle via a gas diffuser. The gas diffuser is made of a phenolic compressed compound and it functions as an electric insulator by means of which the shielding gas is diffused and the insulation between the inner pipe and the outer pipe is effectuated at the appertaining ends of the pipes. For this reason, the gas holes cannot be cleaned at the same time as the cleaning of the flow nozzle and of the gas nozzle with a milling tool. The gas diffuser is mounted so as to be rotatable around the rotational axis of the milling tool. As a result, even though the mechanical stress caused by removed spatter during the cleaning procedure is minimized, optimal cleaning cannot be achieved by means of the milling tool. In other words, with this design, the use of (compressed-air operated) milling tools is not possible. As an alternative here, the state of the art offers a spatter protection means which ensures insulation, as a result of which, however, the positive effect of a laminar gas feed through the gas diffuser cannot be implemented.

In the case of other prior-art torch necks of the model series “ABIROB® TWIN 600W” manufactured by the applicant, the shielding gas is fed decentrally in the inner pipe. The shielding gas stream exits radially via holes drilled in the inner pipe. The shielding gas flows axially to a spatter protection means which once again feeds it radially into the gas nozzle. The gas diffuser is made of a phenolic compressed compound and the spatter protection means is made of fiberglass-silicone. The gas diffuser and the spatter protection means are mounted so as to be rotatable. As a result, it is likewise not possible to clean the gas holes at the same time as the cleaning of the contact tip and the gas nozzle with the milling tool.

On the basis of the preceding elaborations, it follows that the structural requirements made of flow laminarization run counter to attaining a maximized transfer of the process heat. Moreover, a drawback of the prior-art torches is that automated cleaning, for instance, by means of a milling tool, is not possible without causing damage to the wearing parts. Furthermore, a disadvantage of the prior-art torches is that the gas nozzle and the gas diffuser are not a single module, but rather, separate components that can easily be lost, particularly when they are being replaced, since they are not captively joined to each other.

Before the backdrop of the above-mentioned drawbacks, the invention is based on an objective of putting forward an improved gas nozzle and an improved torch neck that allow automated cleaning of the torch, especially by means of a milling tool, even if the gas feed for a shielding gas stream flowing laminarly is decentralized, that is to say, through channels inside a (composite) inner pipe.

### SUMMARY OF THE INVENTION

According to the invention, a gas nozzle is provided for the outflow of a shielding gas stream out of a gas outlet having a gas diffuser section, wherein the gas nozzle, at least in a partial area of the gas diffuser section, is configured with a double wall in order to create a flow space for the shielding gas stream.

In this manner, an additionally delimited flow space or a hollow space is created inside the module, that is to say, between the gas nozzle and the gas diffuser section, or else the transitions to this flow space or out of this flow space are created.

The flow channel for the shielding gas stream is lengthened by diverting the shielding gas stream in the double-walled gas diffuser section so that the desired laminar flow is adjusted at the front end of the torch head, in spite of the fact that, for purposes of attaining a maximized transfer of process heat, it has a shorter gas nozzle than prior-art systems.

The gas nozzle is shortened as compared to prior-art nozzles in order to position the liquid cooling as close as possible to the heat source (welding process), that is to say, the distance from the heat source to the cooling circulation system is as short as possible.

With a decentralized gas diffusion, the diffusion and laminarization of the shielding gas stream in the gas nozzle are no longer implemented via the inner pipe or the nozzle holder. Moreover, the holes of the separate gas diffuser cannot be mechanically cleaned using a milling tool. In this manner, the laminar flow can form at the front end of the torch head, even in the case of the shortened gas nozzle. Owing to the configuration according to the invention of the gas nozzle with an additionally delimited flow space inside the module, that is to say, between the gas nozzle and the gas diffuser section, the minimal distance from the source of process heat to the cooling circulation system allows the shielding gas stream to be laminarized and, at the same time, the gas holes of the integrated gas diffuser can be automatically cleaned using the milling tool. In other words, the torch can withstand automated cleaning by means of the milling tool.

According to a first advantageous refinement of the invention, the gas diffuser section and the gas nozzle are formed monolithically. For instance, the gas nozzle with the gas diffuser section can be made particularly easily and efficiently employing 3D printing.

As an alternative, it is conceivable for the gas diffuser section to be formed by a gas diffuser that is attached to the gas nozzle. In this manner, the gas nozzle and the gas diffuser form a module. Moreover, the loss of components is prevented in that the gas diffuser section is captively joined to the gas nozzle. Particularly when the gas nozzle is being replaced, that is to say, also when it is not screwed to the torch, the gas diffuser is captively held on the gas nozzle.

According to another advantageous configuration of the invention, it is provided for the gas diffuser section to have at least one gas outlet opening along its circumference, especially several gas outlet openings, arranged approximately at the same distance from each other, so that the gas outlet is fluidly connected to the gas outlet opening(s). It is through these gas outlet openings that the shielding gas flows in a uniformly diffused manner along the circumference as a function of the radial distribution of the openings. The gas exiting via the openings is thus deflected and diverted in the gas nozzle, resulting in an improved flow of the shielding gas in the direction of the gas outlet in terms of the laminarity.

For this reason, it is advantageous to arrange the gas outlet openings in an additional component that is mounted on the gas nozzle and that can withstand cleaning using a milling tool. At the same time, the module consisting of the gas nozzle and the additional component creates an extension of the flow channel for the shielding gas where the desired laminar flow can already be formed at the front end of the torch neck.

In an advantageous refinement of the invention, the inner diameter of the gas nozzle defined by the gas nozzle and the adjacent gas diffuser section surface is configured so as to be uniform downstream from the gas stream or else conically decreasing, as seen in the direction of flow, that is to say, tapered. In this manner, the milling tool, which is especially guided by a machine, can be inserted into the gas nozzle without any problem and can be moved all the way to the gas outlet openings, thus achieving a simple cleaning of the gas nozzle and of the gas outlet openings.

Another advantageous variant of the invention provides for the gas diffuser to be made of a metal material, especially copper or of a copper alloy or else of a ceramic. A metal material, however, is particularly advantageous in this context since the gas outlet openings cannot undergo automated cleaning with a milling tool in the case of the usual ceramic or polymer materials. Although modern machinable glass ceramics can be used, as a rule, they are very expensive and laborious to press.

This is why at least the gas diffuser section of the gas nozzle is preferably made of a metal material in order to allow automated cleaning of the gas holes, especially in the case of a decentralized gas diffusion. Moreover, damage during milling is very unlikely to occur since metal material exhibits a high impact resistance. A high degree of hardness is required of the material in order to withstand the abrasive forces during cleaning with a milling tool. As set forth in the invention, implementation using impact-resistant, hard and temperature-resistant non-metallic materials is likewise conceivable.

In a refinement of the invention, the gas diffuser is essentially flush with the gas nozzle, at least in certain sections. In this manner, the milling tool, which is especially guided by machine, can be easily inserted into the gas nozzle and moved all the way to the gas outlet openings, so that optimal cleaning is possible. The internal components, especially the contact tip and its holder, do not need to be modified for this purpose.

According to another advantageous embodiment of the invention, the gas diffuser is joined to the gas nozzle with a positive and/or a non-positive and/or a bonded connection.

The term “positive or non-positive connections” is to be understood such that they are based on the fact that connecting elements transmit forces in that they press the joining surfaces against each other. A friction resistance that is greater than the forces acting onto the connection from the outside is created between the surfaces. In the case of a non-positive connection, forces and torques are transmitted by friction forces.

Positive connections are created in that the shape of the workpieces or connecting elements that are to be connected allow the force transmission, thus creating the cohesion. Positive connections are generated by the intermeshing of at least two mating parts. As a result, the mating parts cannot become detached, even with or without an interruption of the transmission of force. To put it in a different way, in a positive connection, one of the connection parts stands in the way of the other one. With a positive connection, the workpieces are connected by shapes that fit into each other.

Bonded connections are created by integrally uniting materials, that is to say, the workpieces are joined together by cohesion (cohesive force) and adhesion (adhesive force). In other words, the connecting parts are held together by forces on the atomic or molecular level. At the same time, these are undetachable connections such as, for example, soldering, welding, gluing or vulcanizing, which can only be separated by destroying the connecting means.

According to another advantageous variant of the invention, it is provided for the gas diffuser to be detachably connected to the gas nozzle, especially by being screwed or pressed into it. As an alternative, it can be provided for the gas diffuser to be firmly connected to the gas nozzle, especially by being glued on, soldered to or pressed into the gas nozzle. In this manner, a positive and/or non-positive connection of the gas diffuser to a welding torch is achieved. Incidentally, the term “detachable connections” refers to the fact that they can be separated without a component or the connecting means being destroyed in the process. In contrast, undetachable connections can only be separated by destroying the component or the connecting means.

Moreover, the gas diffuser can be configured so as to be annular, rotation-symmetrical or slotted. Preferably, eight rotation-symmetrical outlet openings are used and the gas diffuser is pressed into the gas nozzle over an edge surface situated on the outer circumference of the gas diffuser. Advantages of the embodiment with eight holes are that this provides sufficient “accumulation surface” for shielding gas while, at the same time, eight outlet openings are enough to attain the requisite volume flow for a stable joining process.

According to an independent idea of the invention, a torch neck for thermally joining at least one workpiece, especially for arc joining, preferably for arc welding or arc soldering, is provided, and it has an electrode arranged in the torch neck or a wire for generating an arc between the electrode or the wire and the workpiece. Moreover, the torch neck has a gas nozzle for the outflow of a shielding gas stream out of a gas outlet. This gas nozzle can be a gas nozzle like the one described above.

As mentioned above, the welding process involving welding torches, particularly machine torches, can give rise to impurities on the gas nozzle and on the gas outlet openings. These contaminated components are cleaned by means of a milling tool and are freed of weld spatter in this manner. Consequently, the wearing parts, especially the gas nozzle, the contact tip or the insulation all have to withstand the mechanical stress during milling.

In the state of the art, these gas outlet openings are located on a polymer or ceramic material component which concurrently serves as electric insulation between the inner and outer pipes of the torch head. A disadvantage here is that the milling tool used for cleaning does not reach all to way to the appertaining polymer or ceramic material component. On the other hand, the risk of damage to the wearing parts caused by the milling tool would be far too great.

These disadvantages are avoided in the case of the torch neck according to the invention. Particularly when it comes to torches with an inner and an outer pipe, the transfer of current and process heat can only take place via the inner pipe. For this reason, it is favorable for the shielding gas stream to be fed via the outer pipe or between the inner and outer pipes. In order to increase the time for the flow laminarization at the front end of the torch, a provision is made for the additional cross-sectional and directional-flow modifications based on the geometry of the gas nozzle.

The configuration of the torch neck with an appropriate geometry of the gas nozzle having a gas diffuser section and gas outlet openings—wherein the gas nozzle, at least in a partial area of the gas diffuser section, is configured with a double wall in order to create a flow space for the shielding gas stream—ensures a sufficient retention time for the rectification and laminarization of the shielding gas stream due to the suitable geometry, even at a small distance from the source of heat.

According to a first advantageous embodiment of the invention, an inner pipe of the torch neck that is electrically connected to a contact tip is electrically insulated by an electric insulator vis-à-vis an outer pipe of the torch neck that is at a distance from the inner pipe.

In the prior-art torches, an insulated gas diffuser is employed which not only diffuses the shielding gas but also effectuates the insulation between the inner and outer pipes at the appertaining pipe ends. This design does not allow automated cleaning, especially using a compressed air-powered milling tool. As an alternative, the state of the art suggests a spatter protection means which ensures insulation but, as a result, the positive effect of a laminar gas feed through the gas diffuser cannot be achieved.

In the case of a decentralized gas feed, the shielding gas is fed in a double wall of the inner pipe. As a result, the inner pipe is actually a composite pipe or a combined pipe-in-pipe, wherein one pipe is profiled so that interstices are formed between the two pipe walls.

The electric insulation is situated between the inner pipe and the outer pipe, preferably with a cover at the end of both pipes. In this context, the outer parts of the torch are electrically insulated from the inner pipe in order to prevent the welding currents from flowing over the torch housing. During the welding process, the welding wire heats up and this heat is partially fed into the welding torch.

It can be provided for the insulation to be configured in such a way that its function is separate from the function of feeding the gas. The wearing part for the electric insulation between the inner and outer pipes can be designed so as to be simpler and thus more cost-effective. Moreover, it is possible to use the milling tool for the cleaning without causing damage to the wearing parts.

Owing to the separation between the insulation and the flow feed for the spatter protection means, the insulation can be configured with a considerably simpler structure and a thick wall, and can be, for example, in the form of a cover and a spacer at the end of the front pipe ends of the inner and outer pipes in the form of the gas nozzle tip holder. This translates into a marked improvement, especially of the crash safety, that is to say, the positional stability of the torch neck under abrupt mechanical stress, particularly if the welding torch collides with the workpiece, in addition to which a non-insulating gas diffuser or gas diffuser section can be implemented in the gas nozzle.

In another advantageous refinement of the torch neck according to the invention, a filter ring made of sintered material is provided for pressure-reduction purposes, wherein the filter ring is installed in the gas nozzle downstream in a partial area of the gas diffuser section that is configured with a double wall. The shortening of the gas nozzle means that the retention time of the shielding gas in the nozzle might no longer be enough to ensure laminarization of the gas. This is why the filter ring made of sintered material is provided for pressure-reduction purposes.

According to another advantageous embodiment of the invention, a spatter protection means is provided for protection against weld spatter. The shielding gas flows via the gas diffuser or via the gas diffuser section axially to the spatter protection means and is fed radially by the latter once again into the gas nozzle. The spatter protection means preferably consists of a temperature-resistant insulator such as fiberglass-filled PTFE and, during cleaning of the contact tip and the gas nozzle using the milling tool, it is at a sufficient distance to the latter so that the spatter protection means is not damaged by the milling tool.

According to another independent idea of the invention, a torch is provided which has a neck, especially a neck of the kind described above.

According to another independent idea of the invention, a method is provided for thermally joining at least one workpiece, especially for arc joining, preferably arc welding or arc soldering, having an electrode to generate an arc between the electrode and the workpiece. A shielding gas stream flows out of the gas nozzle, especially a gas nozzle of the kind described above. The direction of flow of the shielding gas is modified at least once by means of a gas diffuser section or a gas diffuser so that the duration of flow is prolonged or the flow path of the shielding gas stream inside the gas nozzle is lengthened, wherein the shielding gas stream surrounds the electrode essentially annularly at the gas outlet of the gas nozzle.

Additional objectives, advantages, features and application possibilities of the present invention can be gleaned from the description below of an embodiment making reference to the drawing. In this context, all of the described and/or depicted features, either on their own or in any meaningful combination, constitute the subject matter of the present invention, also irrespective of their compilation in the claims or in the claims to which they refer back.

### DESCRIPTION OF THE DRAWINGS

In this context, the following is shown, at times schematically:

FIG. 1 part of a torch neck of a welding torch having a gas nozzle,

FIG. 2 a detailed view of the gas nozzle with a gas diffuser section,

FIG. 3 a detailed view of the gas nozzle, wherein the gas diffuser section and the gas nozzle are configured monolithically,

FIG. 4 a sectional view of the torch neck as shown in FIG. 1, and

FIG. 5 a part of a torch neck as shown in FIGS. 1 and 7, with a milling tool.

### DETAILED DESCRIPTION

For the sake of clarity, identical components or those having the same effect are provided with the same reference numerals in the figures of the drawing shown below, making reference to an embodiment.

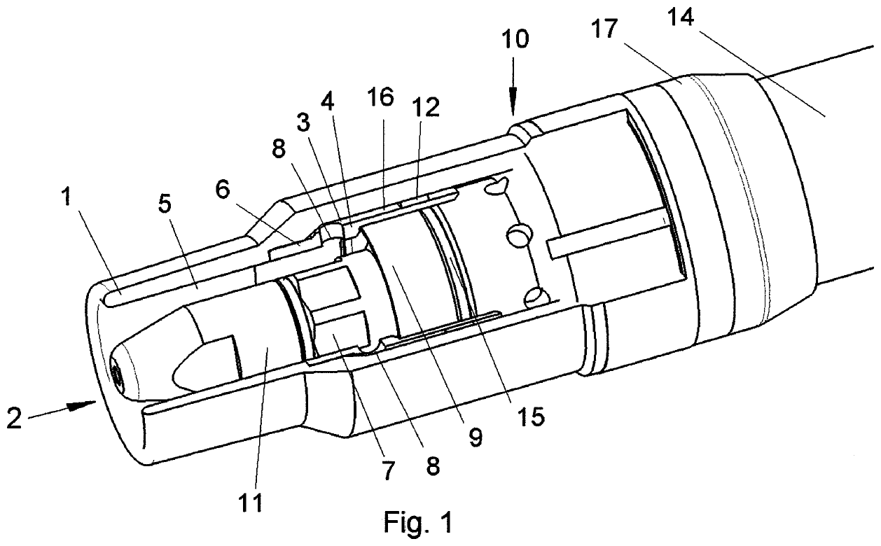

FIG. 1 shows a torch neck 10 with a nozzle tip holder 7 of a welding torch for thermally joining at least one workpiece, especially for arc joining, preferably arc welding or arc soldering. “MIG”, “MAG” and “TIG” are standard welding methods that are employed in sheet metal processing.

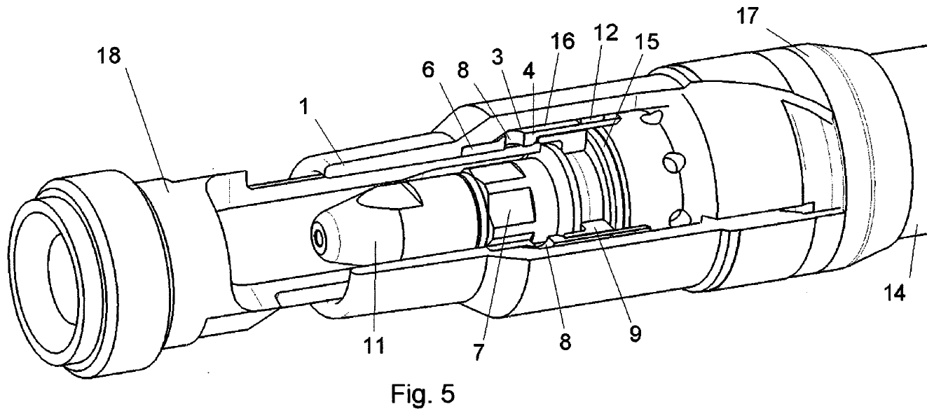

FIG. 5 differs from FIG. 1 in that a milling tool 18 is additionally depicted.

When it comes to shielding gas-assisted arc welding methods employing a consumable electrode (MSG), “MIG” stands for “metal inert gas” and “MAG” stands for “metal active gas”. MAG welding is a metal shielding-gas process (MSG) with active gas in which the arc burns between a continuously fed, consumable wire electrode and the material. The consuming electric supplies the filler material to form the weld seam.

In the case of shielding gas-assisted arc welding methods employing a non-consumable electrode (TSG), “TIG” stands for “tungsten inert gas”. The welding devices according to the invention can be configured as machine-controlled welding torches.

Arc welding devices generate an arc between the workpiece and a consumable or non-consumable welding electrode in order to fuse the material that is to be welded. A shielding gas stream shields the material that is to be welded as well as the welding site against the atmospheric gases, mainly N₂, O₂, H₂, that are present in the ambient air.

In this context, the welding electrode is provided on a torch body of a welding torch that is connected to an arc welding device. The torch body normally has a group of internal components that carry the welding current and that conduct the welding current from a source of welding current in the arc welding device to the tip of the torch head and to the welding electrode, where it then generates the arc to the workpiece.

The shielding gas stream flows around the welding electrode, the arc, the welding bath and the heat-affected zone on the workpiece, and in this process, it is fed to these areas via the body of the welding torch. A gas nozzle 1 conveys the shielding gas stream to the front end of the torch head, where the shielding gas stream exits from the torch head around the welding electrode in an approximately annular pattern.

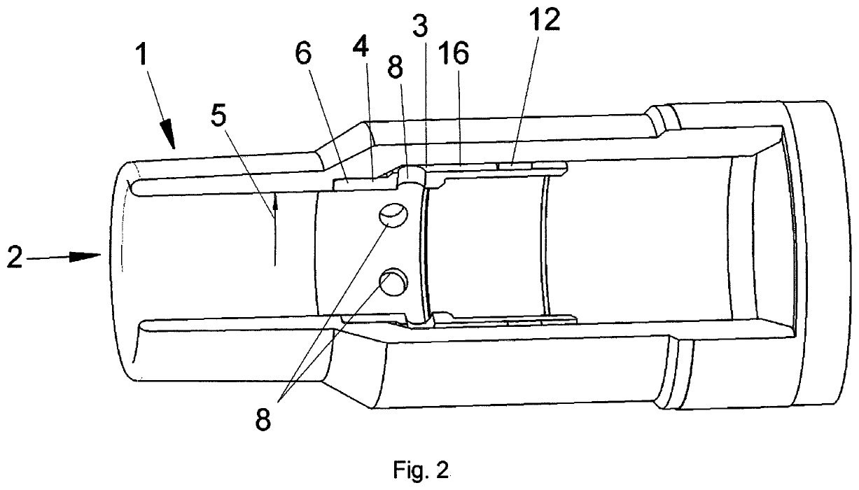

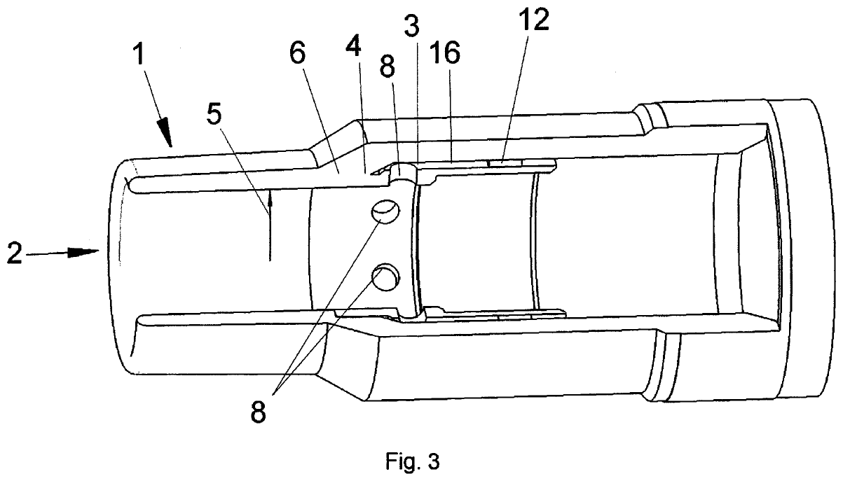

In the present embodiment, the torch neck 10 shown in FIGS. 1 and 5 and belonging to the torch head of the welding torch comprises the gas nozzle 1 for the outflow of a shielding gas stream out of a gas outlet 2 located at the front end of the gas nozzle 1. Such gas nozzles 1 are presented in detail in FIGS. 2 and 3.

FIGS. 1 to 3 and 5 also show that the gas nozzle 1, at least in a partial area of the gas diffuser section 3, is configured with a double wall in order to create a flow space 16 for the shielding gas stream. Thus, the configuration of the torch neck 10 with an appropriate geometry of the gas nozzle 1 having the gas diffuser section 3 and the gas outlet openings 8 ensures a sufficient retention time for the rectification and laminarization of the shielding gas stream, even at a small distance from the source of heat.

The embodiments of the gas nozzle 1 as shown in FIG. 2 and FIG. 3 differ in that the gas diffuser section 3 and the gas nozzle 1 as shown in FIG. 3 are formed monolithically. For instance, the gas nozzle with the gas diffuser section can be made particularly easily and efficiently employing 3D printing.

In contrast, FIG. 2 shows that the gas diffuser section 3 is formed by a gas diffuser 4 installed on the gas nozzle 1. In this manner, the gas nozzle 1 and the gas diffuser 4 constitute a module.

In both embodiments of the gas nozzle 1 according to FIG. 2 and FIG. 3, the gas diffuser section 3 has several gas outlet openings 8 arranged along its circumference approximately at an equal distance from each other, so that the gas outlet 2 is fluidly connected to the gas outlet openings 8.

It is through these gas outlet openings 8 that the shielding gas flows in a uniformly diffused manner over the circumference as a function of the radial distribution of the openings 8. The shielding gas stream exiting via the gas outlet openings 8 is thus deflected and diverted in the gas nozzle 1, resulting in an improved flow of the shielding gas in the direction of the gas outlet 2 in terms of the laminarity.

The module consisting of the gas nozzle 1 and the gas diffuser 4 or gas diffuser section 3 creates an extension of the flow channel for the shielding gas where the desired laminar flow can already be formed at the front end of the torch neck.

As can also be seen in FIGS. 1 to 5, the inner diameter 5 of the gas nozzle 1 defined by the gas nozzle 1 and by the adjacent gas diffuser section surface 6 is configured so as to be uniform downstream from the shielding gas stream or else conically decreasing, as seen in the direction of flow, that is to say, tapered. The welding process involving welding torches, particularly machine torches, can give rise to impurities on the gas nozzle 1 and on the gas outlet openings 8. These contaminated components are cleaned in an automated process by means of a milling tool 18, and are freed of weld spatter in this manner. Consequently, the wearing parts, especially the gas nozzle 1, the contact tip 11 or the spatter protection means 19 all have to withstand the mechanical stress during milling. Such a milling tool 18 is depicted in FIG. 5.

Owing to the configuration of the inner diameter 5 of the gas nozzle 1, the machine-guided milling tool 18 can be inserted into the gas nozzle 1 without any problem and moved all the way to the gas outlet openings 8 that are to be cleaned. For this reason, the gas diffuser 4 or gas diffuser section 3 arranged on the gas nozzle 1 can withstand being cleaned by means of a milling tool 18.

In the case of a multi-part configuration of the gas nozzle 1 having a gas diffuser 4 as shown in FIG. 2, the gas diffuser 4 is essentially flush with the gas nozzle 1, at least in certain sections. This allows optimal cleaning of the gas nozzle 1. The inner components, especially the contact tip 11 and its holder, do not need to be modified for this purpose. Consequently, automated cleaning using the milling tool 18 is easily possible.

In the case of the configuration of the gas nozzle 1 as shown in FIG. 2, the gas diffuser 4 is joined to the gas nozzle 1 with a positive and/or a non-positive and/or a bonded connection 1. In particular, it is conceivable for the gas diffuser 4 to be detachably connected to the gas nozzle 1, especially by being screwed or pressed into it. As an alternative, it is conceivable for the gas diffuser 4 to be firmly connected to the gas nozzle 1, especially by being glued on, soldered to or pressed into the gas nozzle 1.

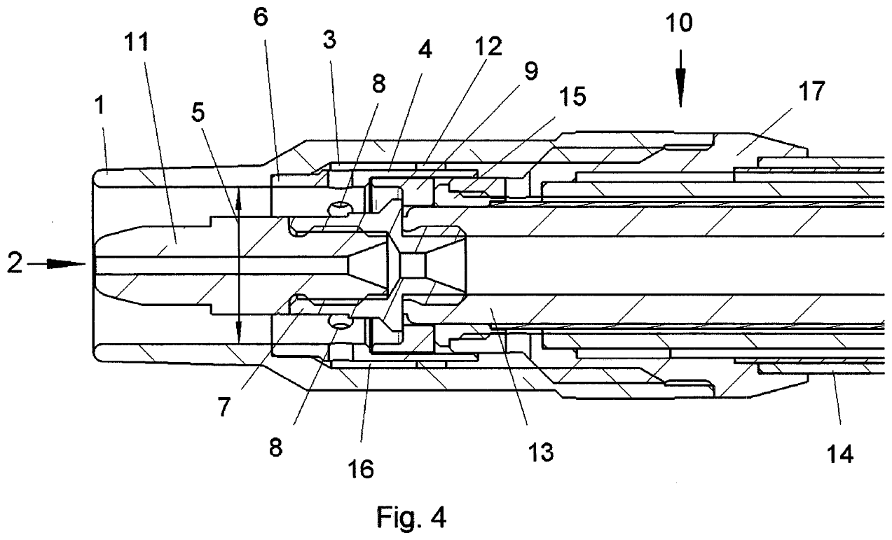

As can be seen in the sectional view of the torch neck 10 as shown in FIG. 4 as well as in FIG. 1 and FIG. 5, an inner pipe 13 of the torch neck 10 that is electrically connected to a contact tip 11 is electrically insulated by the insulation cap 15 vis-à-vis the outer pipe 14 of the torch neck 10 that is at a distance from the inner pipe 13, preferably with a cover at the end of both pipes 13 and 14. The external parts of the torch or torch neck 10 are electrically insulated from the inner pipe 13 in order to prevent the welding currents from flowing over the torch housing.

Here, the gas nozzle carrier 17 not only has a function as a carrier for the gas nozzle 1 but also the function of diffusing the shielding gas. For this reason, the spatter protection means 9 and the insulation cap 15 can be configured so that their function is separate from the function of feeding the shielding gas. Therefore, the spatter protection means 9 can be configured so as to have a solid wall and consequently be sturdier than is the case with conventional designs in which shielding gas is fed through the spatter protection means via a hole. The insulation cap 15, in contrast, only has the task of positioning the pipes and the insulation, but does not have to seal off any media that is flowing through.

The shielding gas stream is conveyed in a double wall of the inner pipe 13. Due to the separation of the electric insulation 15 and the flow feed of the shielding gas, the electric insulation can be configured, for example, in the form of a cover and a spacer, at the end of the front ends of the inner pipe 13 and outer pipe 14.

As can also be seen in FIG. 1, FIG. 4 and FIG. 5, a spatter protection means 9 is provided as protection against weld spatter during the welding procedure. The shielding gas stream flows via the gas diffuser 4 or the gas diffuser section 3 axially to the spatter protection means 9 and is radially fed by the latter once again into the gas nozzle 1. The spatter protection means 9 preferably consists of fiberglass-filled PTFE and, during the cleaning of the contact tip 11 and of the gas nozzle 1 using the milling tool 18, it is at a sufficient distance from the latter so that the spatter protection means 9 is not damaged by the milling tool 18.

Here, the spatter protection means 9 fulfills a double function in that it is not only provided as protection against weld spatter but also assumes the function of the electric insulator 15. In this manner, a single component, namely, the spatter protection means 9 or the electric insulator 15, has a dual function.

Owing to the shortening of the gas nozzle 1, it can happen that the retention time of the shielding gas stream in the gas nozzle 1 is no longer sufficient to ensure laminarization of the shielding gas. For this reason, a filter ring 12 made of sintered material is provided for pressure-reduction purposes. The filter ring 12 is installed in the gas nozzle 1 downstream in a partial area of the gas diffuser section 3 that is configured with a double wall.

### LIST OF REFERENCE NUMERALS

1 gas nozzle
2 gas outlet
3 gas diffuser section
4 gas diffuser
5 inner diameter
6 gas diffuser sectional surface
7 nozzle tip holder
8 gas outlet opening
9 spatter protection means
10 torch neck
11 contact tip
12 filter ring
13 inner pipe
14 outer pipe
15 insulation cap
16 flow space
17 gas nozzle carrier
18 milling tool

1. A gas nozzle (1) for the outflow of a shielding gas stream out of a gas outlet (2), comprising:
a gas diffuser section (3) with a double wall at least in a partial area thereof in order to create a flow space (16) for the shielding gas stream.

2. The gas nozzle (1) according to claim 1, wherein the gas diffuser section (3) and the gas nozzle (1) are formed monolithically.

3. The gas nozzle (1) according to claim 1, wherein the gas diffuser section (3) is formed by a gas diffuser (4) that is attached to the gas nozzle (1).

4. The gas nozzle (1) according to claim 1, wherein the gas diffuser section (3) has two or more gas outlet openings (8) along its circumference so that the gas outlet (2) is fluidly connected to the gas outlet openings (8).

5. The gas nozzle (1) according to claim 1, wherein the gas nozzle (5) has an inner diameter that is defined by the gas nozzle (1) and the adjacent gas diffuser section surface (6), and wherein said inner diameter is configured so as to be uniform downstream from the gas stream or else conically decreasing.

6. The gas nozzle (1) according to claim 1, wherein the gas diffuser (4) is made of a metal or is made of impact-resistant glass ceramics.

7. The gas nozzle (1) according to claim 1, wherein the gas diffuser section (3) or the gas diffuser (4) is substantially flush with the gas nozzle (2), at least in certain sections.

8. The gas nozzle (1) according to claim 3, wherein the gas diffuser (4) is joined to the gas nozzle (1) with a positive connection and/or a non-positive connection and/or a bonded connection.

9. The gas nozzle (1) according to claim 3, wherein the gas diffuser (4) is detachably connected to the gas nozzle (1).

10. The gas nozzle (1) according to claim 3, wherein the gas diffuser (4) is non-detachably connected to the gas nozzle (1).

11. A torch neck (10) for arc joining at least one workpiece, comprising:
an electrode arranged in the torch neck (10) or a wire for generating an arc between the electrode or the wire and the workpiece, and
a gas nozzle (1) for the outflow of a shielding gas stream out of a gas outlet (2), said gas nozzle (1) comprising a gas diffuser section (3) with a double wall at least in a partial area thereof in order to create a flow space (16) for the shielding gas stream.

12. The torch neck (10) according to claim 11, further comprising a filter ring (12) made of sintered material and configured to reduce pressure installed in the gas nozzle (1) downstream in a partial area of the gas diffuser section (3) that is configured with the double wall.

13. The torch neck (10) according to claim 11, further comprising an inner pipe (13) of the torch neck (10) that is electrically connected to a contact tip (11) and that is electrically insulated by an electric insulator (15) vis-à-vis an outer pipe (14) of the torch neck that is at a distance from the inner pipe (13).

14. The torch neck (10) according to claim 11, further comprising a spatter protection means (9) comprising of fiberglass-filled PTFE installed before an insulation cap (15).

15. A torch having a torch neck (10) according to claim 11.

16. A method for arc joining at least one workpiece, comprising:
providing an electrode or a wire for generating an arc between the electrode or the wire and the workpiece,
directing a shielding gas stream out of a gas nozzle (1), said gas nozzle (1) comprising a gas diffuser section (3) with a double wall at least in a partial area thereof in order to create a flow space (16) for the shielding gas stream, and
modifying a direction of flow of the shielding gas at least once with the gas diffuser section (3) so that the duration of flow is prolonged or the flow path of the shielding gas stream inside the gas nozzle (1) is lengthened, wherein the shielding gas stream surrounds the electrode or wire essentially annularly at the gas outlet (2) of the gas nozzle (1).
